(19) United States
(12) Patent Application Publication
(10) Pub. No.: US 2009/0090587 A1
(43) Pub. Date: Apr. 9, 2009

(54) Speed Responsive Damper and Impact Absorbing Damper Device

(75) Inventor: Shigemitsu Tomita, Kanagawa-ken (JP)

Correspondence Address: KANESAKA BERNER AND PARTNERS LLP, 1700 DIAGONAL RD, SUITE 310, ALEXANDRIA, VA, 22314-2848, US

(73) Assignee: NIFCO INC., Yokohama-shi (JP)

(21) Appl. No.: 12/225,809

(22) PCT Filed: Dec. 28, 2006
(86) PCT No.: PCT/JP2006/326413

§ 371 Date: Nov. 24, 2008

(30) Foreign Application Priority Data
Mar. 31, 2006 (JP) 2006-096981

(51) Int. Cl. F16F 9/50

(52) U.S. Cl. 188/282.6

(57) ABSTRACT

A speed responsive damper (10) comprises: a cylinder (11) in which a fluid is enclosed; a piston (13) that is slidably fitted into the cylinder and that has an orifice (19a) through which a fluid passes; a piston rod 14 whose one end is fixed to the piston and whose the other end is extended to the outside of the cylinder; and a slider 15 that is installed within the cylinder, and that moves in a predetermined range relative to the piston, and that adjusts an amount of the fluid passing through the piston, wherein the orifice is formed at a front end side of the piston. Therefore, explosive sound of air can be reduced, and swirl or slip of oil can be previously prevented, and a piston rod can be prevented from tilting.

### TECHNICAL FIELD

The present invention relates to a cylinder type oil damper, and more particularly, to a speed responsive damper and an impact absorption damper device using the same that reduce explosive sound of air passing through an orifice and prevent abrupt repulsive power, when a piston displaces in a high speed.

### BACKGROUND ART

In general, a cylinder type oil piston damper has been presented as a structure for partially changing an inner diameter of a cylinder in order to change repulsive power. For example, a damper disclosed in Japanese Patent Application Laid-Open No. 2004-28167, has a configuration of an enlarged diameter part formed by enlarging diameter of an end part of a cylinder, a rebound spring having a large elastic force is provided within the enlarged diameter part, and when a piston reaches the enlarged diameter part, repulsive power is obtained by an elastic force.

Further, in an oil damper shown in FIG. 14, an orifice 3, through which a fluid passes, formed in a piston 2 provided within a cylinder 1 is formed at a rear end side of the piston.

However, in a cylinder type oil piston damper having the above-described configuration, because an inner diameter of the cylinder partially changes, when a load applied to a piston rod abruptly changes, there was a risk that a bubble may generate in a working fluid. If a bubble generates in a working fluid, the piston rod loses a lateral balance, and thus there is a problem that the piston rod tilts. Further, in the oil damper shown in FIG. 14, a generated bubble is exploded after passing through the orifice 3 of the piston 2, and thus there is a problem that explosive sound occurs, or the like.

The present invention has been made in view of the above problems, and an object of the present invention is to provide a speed responsive damper that can reduce explosive sound of air generating when air passes through a piston and in which a rod does not incline, even if a load applied to the rod abruptly changes.

### DISCLOSURE OF THE INVENTION

In order to achieve the above-mentioned object, according to the present invention, a speed responsive damper is characterized in that includes: a cylinder in which a fluid is enclosed; a piston that is slidably fitted into the cylinder and that has an orifice through which a fluid passes; a piston rod whose one end is fixed to the piston and whose the other end is extended to the outside of the cylinder; and a slider that is installed within the cylinder, and that moves in a predetermined range relative to the piston, and that adjusts an amount of a fluid passing through the piston, wherein the orifice is formed at a front end side of the piston.

Further, according to the present invention, the slider is characterized in that has a plurality of rectified protrusion pieces in an inner circumference thereof. Further, according to the present invention, the rectified protrusion piece is characterized in that has a cross-section configured in Fuji mountain shape.

Further, according to the present invention, the rectified protrusion piece is characterized in that has a taper portion at a front end thereof.

Further, according to the present invention, the piston and the slider are characterized in that they are biased by a spring in a separation direction, and when the piston advances in a high speed, the slider retreats while resisting to an elastic force.

According to the present invention, there is provided an embedded type impact absorption damper device in a drawer, comprising the speed responsive damper incorporated in a sliding door, an overhung door, and an opening and closing door.

Since the present invention has the above-described configuration, the following explained effects are obtained.

In the present invention, a speed responsive damper comprises: a cylinder in which a fluid is enclosed: a piston that is slidably fitted into the cylinder and that has an orifice through which a fluid passes; a piston rod whose one end is fixed to the piston and whose the other end is extended to the outside of the cylinder; and a slider that is installed within the cylinder and that moves in a predetermined range relative to the piston, and that adjusts an amount of a fluid passing through the piston, wherein the orifice is formed at a front end side of the piston. Therefore, by previously preventing swirl or slip of oil, an abrupt change of repulsive power or a tilt of a piston rod can be prevented. Further, by causing explosion of air within a circular part of the piston, explosive sound of air occurred can be reduced.

Further, according to the present invention, because the slider has a plurality of rectified protrusion pieces in an inner circumference thereof, a rectifying effect increases and thus swirl or slip of oil can be prevented.

Further, according to the present invention, because the rectified protrusion piece has a cross-section configured in Fuji mountain shape, a rectifying effect increases and thus swirl or slip of oil can be prevented.

Further, according to the present invention, because the rectified protrusion piece has a taper portion at a front end thereof, a rectifying effect of oil can be improved.

Further, according to the present invention, because the piston and the slider are biased by a spring in a separation direction, when the piston advances in a high speed, the slider retreats while resisting to an elastic force. Accordingly, when the piston operates in a high speed, an abrupt change of repulsive power or a tilt of a piston rod can be prevented.

Further, if the speed responsive damper according to the present invention is used in an embedded type impact absorption damper device in a drawer incorporated in a sliding door, an overhung door, and an opening or closing door, when opening or closing the sliding door, or the like, an impact can be previously prevented.

### BRIEF DESCRIPTION OF THE DRAWINGS

FIG. 1 is a cross-sectional view illustrating an entire configuration of a speed responsive damper according to the present invention;

FIG. 2 is an exploded view illustrating an example of the speed responsive damper of FIG. 1;

FIG. 3 is a cross-sectional view illustrating an operation state of the speed responsive damper of FIG. 1;

FIG. 4 is an enlarged cross-sectional view of a major part illustrating a relationship between a piston and a slider in the speed responsive damper;

FIG. 5 is a cross-sectional view of the speed responsive damper taken along line V-V of FIG. 4;

FIG. 6 is an enlarged rear view of the slider of FIG. 4;

FIG. 7 is an enlarged longitudinal cross-sectional view of the slider of FIG. 6;

FIG. 8 is an enlarged front view of the slider of FIG. 6;

FIG. 9 is an enlarged front view of the piston of FIG. 4;

FIG. 10 is a partially enlarged cross-sectional view of the piston of FIG. 9;

FIG. 11 is an enlarged rear view of the piston of FIG. 9;

FIG. 12 is a side view of a piston illustrating another embodiment of the present invention;

FIG. 13 is a perspective view of the piston illustrating in FIG. 12;

FIG. 14 is a cross-sectional view of a major part illustrating an example of a conventional damper;

FIG. 15 is an explanatory diagram illustrating a state of incorporating the speed responsive damper according to the present invention in a drawer;

FIG. 16 is an explanatory diagram illustrating a state of incorporating the speed responsive damper according to the present invention in an opening and closing door;

FIG. 17(a) is an explanatory diagram illustrating a state of incorporating the speed responsive damper according to the present invention in a overhung door; and

FIG. 17(b) is an explanatory diagram illustrating a state where a damper starts to operate when the overhung door of FIG. 17(a) approaches a support frame.

### BEST MODE FOR CARRYING OUT THE INVENTION

In the present invention, by providing an orifice at a front end side of a piston, because air explodes within a circular part of the piston occurs, explosive sound occurred can be reduced, and because a plurality of rectified protrusion pieces are provided in an inner circumference of a slider that can adjust an amount of a fluid passing through the piston, when the piston operates in a high speed, an abrupt change of repulsive power or a tilt of a piston rod can be prevented.

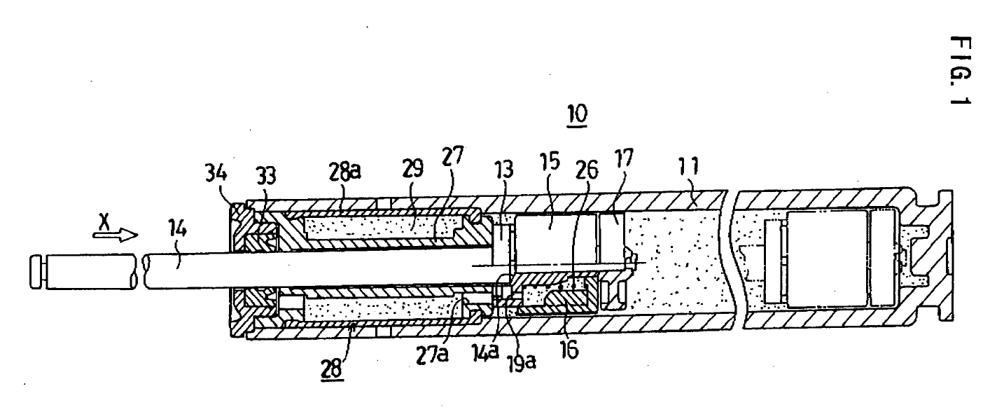

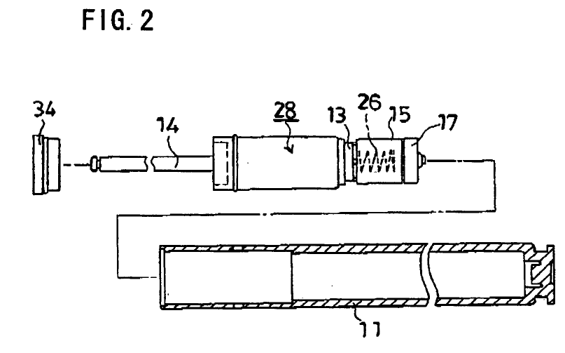

Hereinafter, an embodiment of the present invention is described in detail based on the drawings. FIG. 1 is a cross-sectional view illustrating an entire configuration of a speed responsive damper according to the present invention, FIG. 2 is an exploded view illustrating an example of the speed responsive damper according to the present invention, and FIG. 3 is a cross-sectional view illustrating an operation state of the speed responsive damper according to the present invention. Here, a speed responsive damper 10 includes a cylinder 11 in which a fluid is enclosed; a piston 13 that is slidably fitted into the cylinder and that has an orifice 19a through which a fluid passes; a piston rod 14 whose one end is fixed to the piston 13 and whose the other end is extended to the outside of the cylinder 11; and a slider 15 that is installed within the cylinder 11, and that moves in a predetermined range relative to the piston 13, and that adjusts an amount of a fluid passing through the piston 13, wherein the orifice 19a is formed at a front end side of the piston 13.

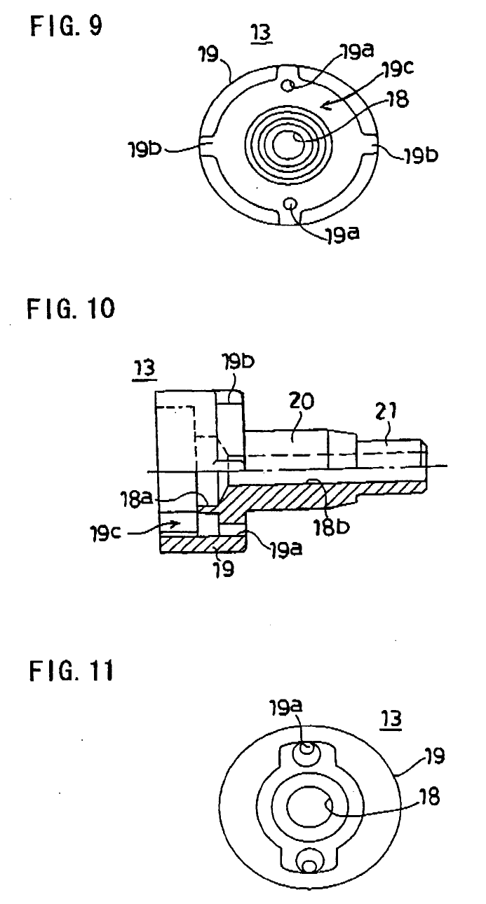

As shown in FIGS. 9 to 11, the piston 13 has a through hole 18 through which the piston rod 14 penetrates at the center thereof. The through hole 18 has a large diameter portion 18a and a small diameter portion 18b, and the small diameter portion 18b cannot pass through a step portion 14a provided around a front end of the piston rod 14. Further, as a latch ring 17 is engaged to a front end groove 14b of the piston rod 14, the piston 13 is fixed to the piston rod 14.

An outer diameter of a circular part 19 of the piston 13 is formed smaller than an inner diameter of the cylinder 11, and a fluid can pass through the circular part 19. Further, as shown in FIGS. 9 to 11, an orifice 19a for passing through a fluid is formed in a front end surface of the circular part 19 and communicates with an enlarged concave portion 19c formed at the inside of the circular part. Further, a plurality of ribs 19b is formed in the circular part 19 in an axis direction. In the present embodiment, four ribs 19b are formed at an interval of 90°. Further, the piston 13 has a first small diameter part 20 and a second small diameter part 21, and the sliders 15 are slidably fitted thereto.

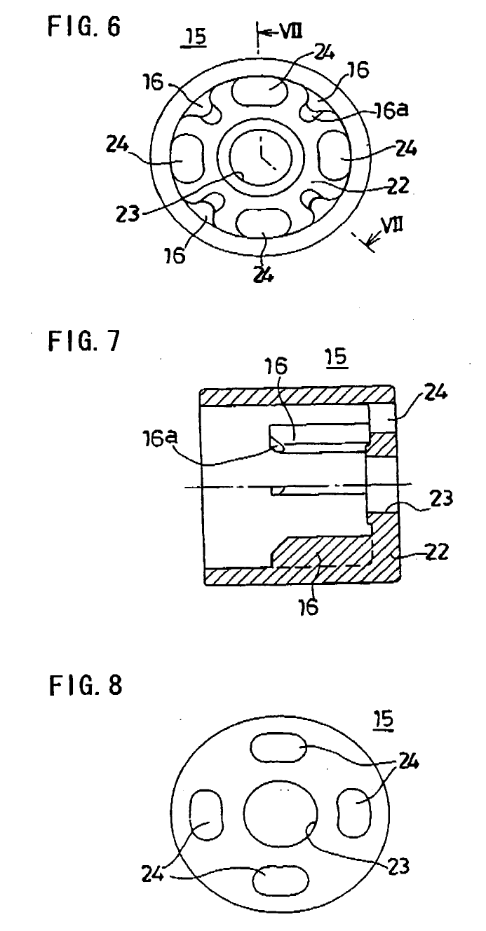

As shown in FIGS. 6 to 8, in the slider 15, one end is opened and the bottom is formed in a cylindrical shape, and the second small diameter part 21 of the piston 13 is fitted into a through hole 23 formed at the center of a bottom 22. Further, a plurality of passage holes 24 for passing through a fluid is formed in the bottom 22. In the present embodiment, the passage hole 24 is formed in a slotted hole shape and may be formed in a circular shape. Further, in an inner circumferential wall of the slider 15, a plurality of rectified protrusion pieces 16 are formed along an axis direction. As shown in FIGS. 5 and 6, the rectified protrusion piece 16 has a cross-section configured in Fuji mountain shape. That is, the rectified protrusion piece 16 protrudes from the inner circumferential wall of the slider 15 with a smooth curved line. Further, the rectified protrusion piece 16 has a chamfered taper portion 16a at the front end thereof.

Further, as shown in FIGS. 1 to 3, an accumulator 28 has an inner liner 27 at the center thereof, includes a cylindrical member 28a having elasticity in an outer circumferential portion thereof, and a concave portion 29 is formed between the inner liner 27 and the cylindrical member 28a.

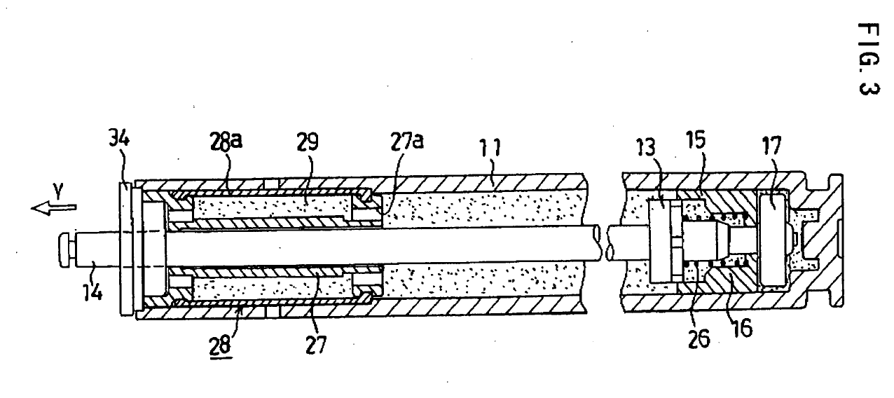

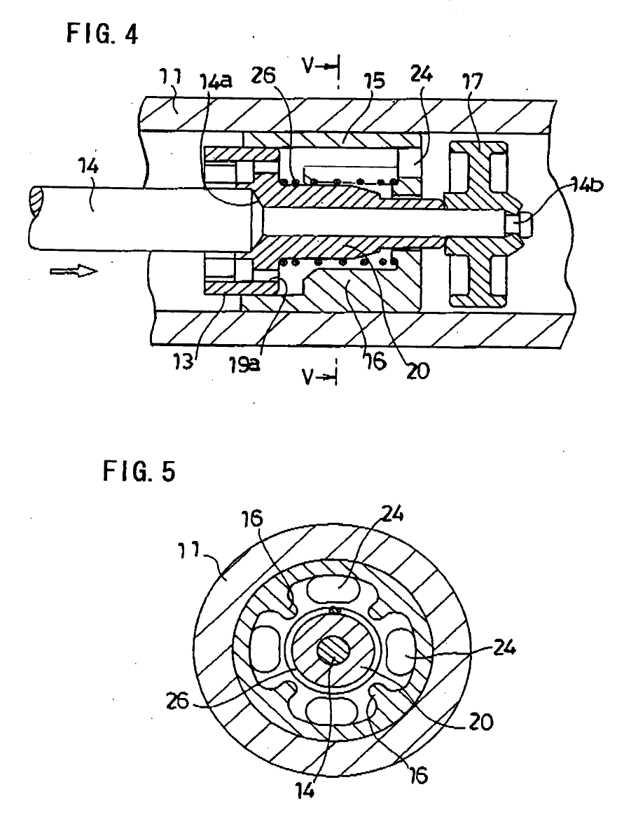

As shown in FIGS. 3 and 4, or the like, the piston 13 and the slider 15 having the above-described configuration are assembled in a state where a coil spring 26 is interposed around a front end of the piston rod 14 and are latched by a latch ring 17 inserted from the front end thereof. Further, in a rear anchor portion of the cylinder 11, the integrally assembled accumulator 28 may be mounted after the piston rod 14 is fitted. The inner liner 27 for configuring the accumulator 28 sets a retreat position of the piston 13, and a fluid is charged in the concave portion 29 formed between the inner liner 27 and the accumulator 28. Further, at a rear end of the inner liner 27, a cap 34 is fitted through an oil seal 33. Because the accumulator 28 having the above-described configuration is integrally assembled and then is assembled from a rear end of the piston rod 14, it can be achieved to improve productivity and reduce space.

The inner liner 27 has a passage 27a, and a fluid flows into the concave portion 29 through the passage 27a. The oil seal 33 is installed around the piston rod 14 and prevents a fluid from leaking from the cylinder 11.

Next, an operation of the speed responsive damper according to the present invention is explained. First, as shown in FIG. 1, at a retreat position of the piston 13, when no load is applied to the piston rod 14, the piston 13 and the slider 15 are separated by a bias force of the coil spring 26. In this state, if an abrupt load is applied to the piston rod 14 in a direction of an arrow X, while the piston 13 advances and the slider 15 retreats while resisting to a bias force of the coil spring 26, as shown in FIG. 4. The piston 13 intrude into inside of the slider 15, and a fluid within the cylinder 11 passes around the rectified protrusion piece 16 and the passage hole 24 and reaches the accumulator 28 via the passage 27a of the inner liner 27 and the orifice 19a formed at a front end of the circular part 19. Therefore, when an abrupt load is applied to the piston rod 14, greater repulsive power may be obtained. Further, in this case, because the orifice 19a is formed at a front end side, braking resistance occurs in an initial stage of passing through the piston, and explosion of air after passing through the orifice occurs in the inside (an enlarged concave portion 19c) of the piston 13 and thus explosive sound is hardly transferred to the outside. Further, because swirl or a bubble is prevented by the rectified protrusion piece 16, a problem such as a tilt of the piston rod 14 is solved. When a slow load is applied to the piston rod 14, a distance between the piston 13 and the slider 15 is sustained by the coil spring 26, whereby normal repulsive power is obtained.

FIG. 3 is a cross-sectional view illustrating a contracted state of a speed responsive damper according to the present invention. In this state, if a load is applied to the piston rod 14 in a direction of an arrow Y, a fluid passes through the orifice 19a of the piston 13, a periphery of the rectified protrusion piece 16, and the passage hole 24 of the slider 15 and flows. Because a working fluid flows around the rectified protrusion piece 16, swirl or a bubble occurred is prevented.

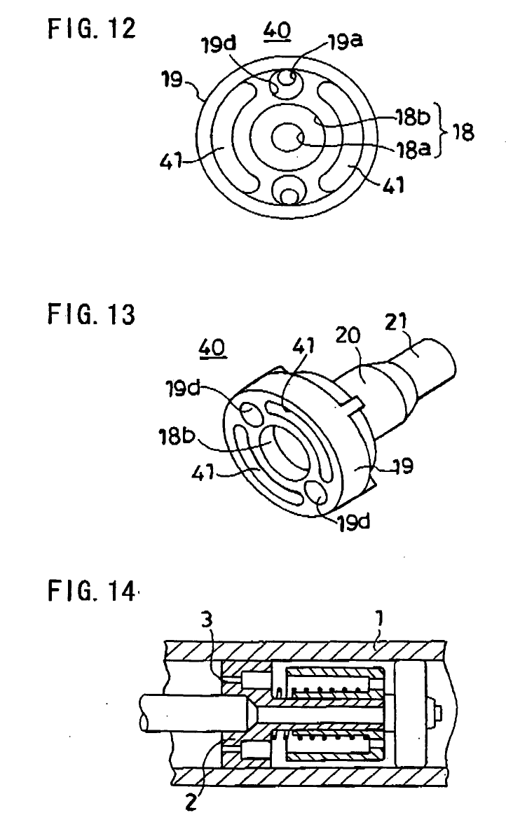

FIG. 12 is a side view of a piston illustrating another embodiment of the present invention, and FIG. 13 is a perspective view of the piston shown in FIG. 12. In the present embodiment, the piston 40 has a through hole 18 through which the piston rod 14 penetrates at the center thereof. The through hole 18 has a large diameter portion 18a and a small diameter portion 18b, and the small diameter portion 18b cannot pass through a step portion 14a formed around a front end of the piston rod 14.

An outer diameter of the circular part 19 of the piston 13 is formed smaller than an inner diameter of the cylinder 11 and a fluid can pass through the circular part 19. Further, as shown in FIG. 12, an orifice 19a for passing a fluid is formed in a front end surface of the circular part 19 and communicates with an enlarged portion 19d formed at the inside of the circular part. Further, a circular arc-shaped concave portion 41 is formed at a rear end side of the circular part 19. Further, the piston 40 has a first small diameter portion 20 and a second small diameter portion 21 thinner than the small diameter portion 20, and the slider 15 is slidably fitted thereto.

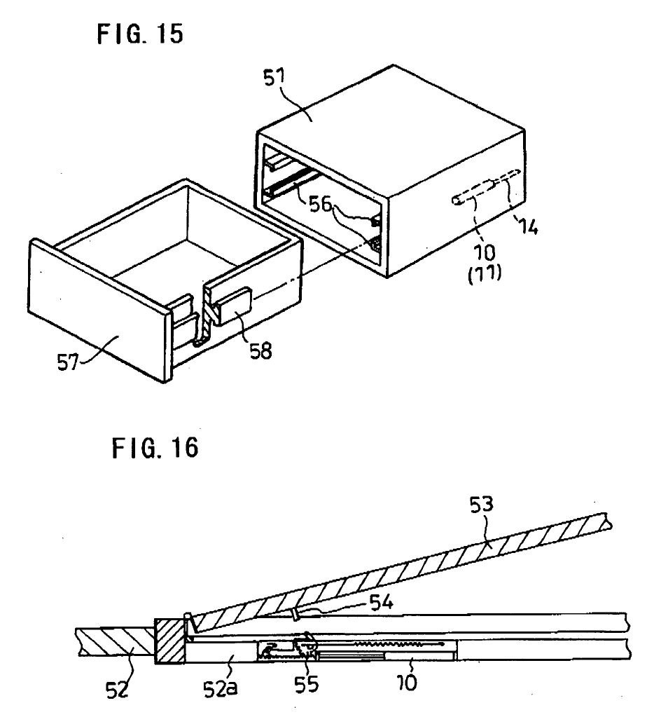

FIG. 15 is an explanatory diagram illustrating a state of incorporating the speed responsive damper according to the present invention in a drawer.

A U-shaped rail 56 is provided at each of both side surfaces of the inside of a case 51, and the speed responsive damper 10 is provided along a front end of the piston rod 14 in which a projection 58 fitted into the rail 56 comes in contact with a front end thereof in both side surfaces of a front plate of a drawer 57 stored in the case 51.

Therefore, even when the drawer 57 is abruptly closed, the protrusion 58 comes in contact with the damper 10, and repulsive power occurs by the damper 10, and the drawer 57 is easily stored in the case 51.

FIG. 16 is an explanatory diagram illustrating a state of assembling the speed responsive damper according to the present invention in an opening and closing door.

Because the speed responsive damper 10 is stored within a case 52a assembled in a window frame 52, a striker 54 of a door 53 withdraws the door 53 by contacting with a withdrawal means 55, and the door is slowly withdrawn and closed while braking by the damper 10.

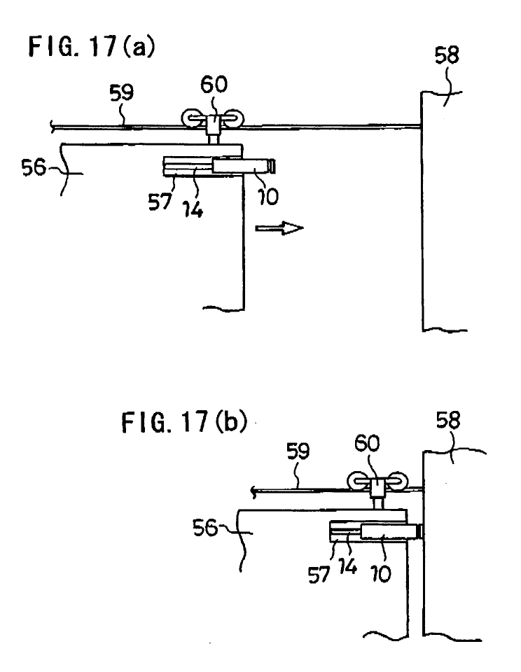

FIGS. 17(a) and (b) are explanatory diagrams illustrating a state where a speed responsive damper according to the present invention is assembled in an overhung door.

An overhung door 56 is movably hung in a rail 59 by a pulley 60. A concave portion 57 is provided in a surface facing a window frame 61 of the overhung door 56, and the damper 10 is buried in the concave portion.

In an embodiment of FIG. 17, a front end of the piston rod 14 is fixed to the bottom of the concave portion 57 by an appropriate method, and the damper 10 is slidably supported within the concave portion 57 so that a front end thereof is protruded.

If the overhung door 56 moves toward the window frame 58 from a state of FIG. 17(a), as shown in FIG. 17(b), a front end of the damper 10 provided in the concave portion 57 of the overhung door comes in contact with the window frame 58, and the piston rod 14 enters within the damper 10, and thus a damper action occurs.

Therefore, even if the overhung door 56 abruptly moves toward the window frame 58, the overhung door 56 is slowly closed by an action of the damper 10, and thus crashing sound does not occur in the window frame.

### INDUSTRIAL APPLICABILITY

As described above, in an oil damper according to the present invention, because an orifice is provided at a front end side in which a piston advances and an enlarged portion is formed at the inside of a circular part, when air passes through the orifice, an explosion occurs at the inside of a circular part, and thus the transfer to the outside of explosive sound of air can be reduced.

Further, by assembling a speed responsive damper according to the present invention in a sliding door, an overhung door, and an opening and closing doors, or the like, an embedded type impact absorption damper device can be used. When a sliding door, or the like, uses an impact absorption damper device, even if a door is abruptly opened or closed, repulsive power is relieved from generating, an impact of a door is suppressed, and a damping force is not damaged.

1. A speed responsive damper (10) comprising:
a cylinder (11) in which a fluid is enclosed;
a piston (13) that is slidably fitted into the cylinder and that has an orifice (19a) through which a fluid passes;
a piston rod (14) whose one end is fixed to the piston and whose the other end is extended to the outside of the cylinder; and
a slider (15) that is installed within the cylinder, and that moves in a predetermined range relative to the piston, and that adjusts an amount of a fluid passing through the piston,
wherein the orifice (19a) is formed at a front end side of the piston.

2. A speed responsive damper according to claim 1 wherein the slider (15) has a plurality of rectified protrusion pieces in an inner circumference thereof.

3. A speed responsive damper according to claim 1 wherein the rectified protrusion piece (16) has a cross-section configured in Fuji mountain shape.

4. A speed responsive damper according to claim 1 wherein the rectified protrusion piece (16) has a taper portion (16a) at a front end thereof.

5. A speed responsive damper according to claim 1 wherein that the piston (13) and the slider (15) are biased by a spring in a separation direction, and thus when the piston advances in a high speed, the slider retreats while resisting to an elastic force.

6. An embedded type impact absorption damper device in which a speed responsive damper of claim 1 is assembled in a sliding door, an overhung door, and an opening and closing door.
